(19) United States
(12) Patent Application Publication
(10) Pub. No.: US 2017/0213394 A1
(43) Pub. Date: Jul. 27, 2017

(54) ENVIRONMENTALLY MAPPED VIRTUALIZATION MECHANISM

(71) Applicant: INTEL CORPORATION, Santa Clara, CA (US)

(72) Inventors: Joshua J. RATCLIFF, San Jose, CA (US); Yan XU, Santa Clara, CA (US)

(21) Appl. No.: 15/329,507

(22) PCT Filed: Sep. 4, 2015
(86) PCT No.: PCT/US2015/048523

§ 371 Date: Jan. 26, 2017

Related U.S. Application Data
(60) Provisional application No. 62/047,200, filed on Sep. 8, 2014.

(51) Int. Cl. G06T 19/20; G06T 15/00; G06T 17/10; G06T 15/04

(52) U.S. Cl. CPC G06T 19/20; G06T 15/04; G06T 15/005; G06T 17/10; G06T 2200/24; G06T 2200/08

(57) ABSTRACT

A method comprising acquiring depth image data, processing the image data into real-time three-dimensional (3D) reconstructed models of the environment, manipulating the models, textures, and images over a set of data, rendering the modified result for display and supporting interaction with the display based on existing spatial and physical skills

This application claims the benefit of priority of U.S. Provisional Application No. 62/047,200, filed Sep. 8, 2014 and is currently pending.

### FIELD

Embodiments described herein generally relate to computers. More particularly, embodiments relate to interactive visualization and augmented reality.

### BACKGROUND

Presently, many systems exist for data visualization, which operate in an abstract space (e.g., diagrams, charts, Google Map overlays, etc.) that require the user to make a mental mapping between the visualization and the meaning of the data. This results in less intuitive and less immersive experiences, and does not leverage the user's understanding of the environment. Current deployments in the space of augmented reality seek to remedy this issue by visually overlaying content on the real world. While this is a step in the right direction, the focus has been on registering in formation at the right spot rather than creating an engaging experience where data transforms the visual and interactive features of user's own environment.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a mapped virtualization mechanism according to one embodiment.

FIG. 2 illustrates a mapped virtualization mechanism according to one embodiment.

FIG. 3A illustrates a screenshot of an exemplary augmented reality application.

FIG. 3B illustrates a screenshot of an exemplary virtual reality effect.

FIG. 3C illustrates a virtualization effect according to one embodiment.

FIG. 4 illustrates a post-processing pipeline according to one embodiment.

FIG. 5 illustrates mapped virtualization process according to one embodiment.

FIG. 6A illustrates a screenshot of a texture manipulation implementation according to one embodiment.

FIG. 6B illustrates a virtual reality implementation according to one embodiment.

FIG. 6C illustrates a screenshot of a post-processing image based manipulation implementation according to one embodiment.

FIG. 7 illustrates computer system suitable for implementing embodiments of the present disclosure according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

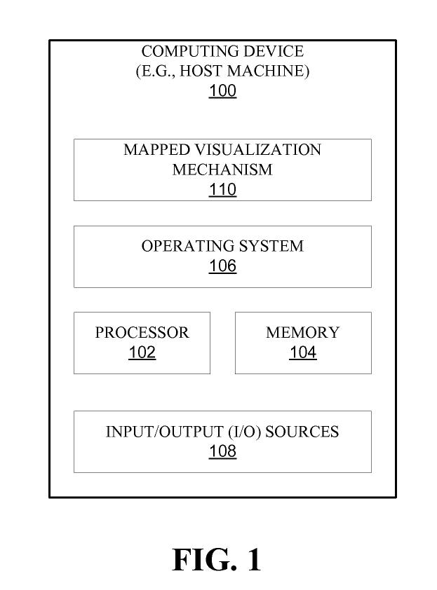

FIG. 1 illustrates one embodiment of a computing device 100. According to one embodiment, computing device 100 serves as a host machine for hosting a mapped visualization mechanism 110. In such an embodiment, mapped visualization mechanism 110 receives data from one or more depth sensing devices (e.g., a camera array or depth camera) to create an engaging experience where data transforms visual and interactive features of a user's environment. In a further embodiment, interactive visualization and augmented reality are implemented to transform the user's existing visual and spatial environment, an to alter its appearance and behavior to suit the needs of an application using a combination of depth sensing, 3D reconstruction and dynamic rendering.

In one embodiment, the visual appearance (e.g., physical geometry, texture, post-process rendering effects) of a user's view of the world is altered of to enable immersive, interactive visualizations. The alteration is implemented by collecting real-time depth data from the depth sensing devices and processing the data into volumetric 3D models, filtered depth maps, or meshes. In a further embodiment, this spatial information subsequently undergoes dynamic rendering effects in accordance with the intent of the visualization.

According to one embodiment, mapped visualization mechanism 110 may be used to visualize various data source, such as sensor data, music streams, video game states etc.

Accordingly, a user may interact with data in a natural way since the data is visualized in a user's immediate environment. For instance, data collected during real-time music analysis enables a lively transformation of the world, where real-world objects appear to expand to the rhythm of the beat and dynamic lighting effects create the sensation of an impromptu disco hall.

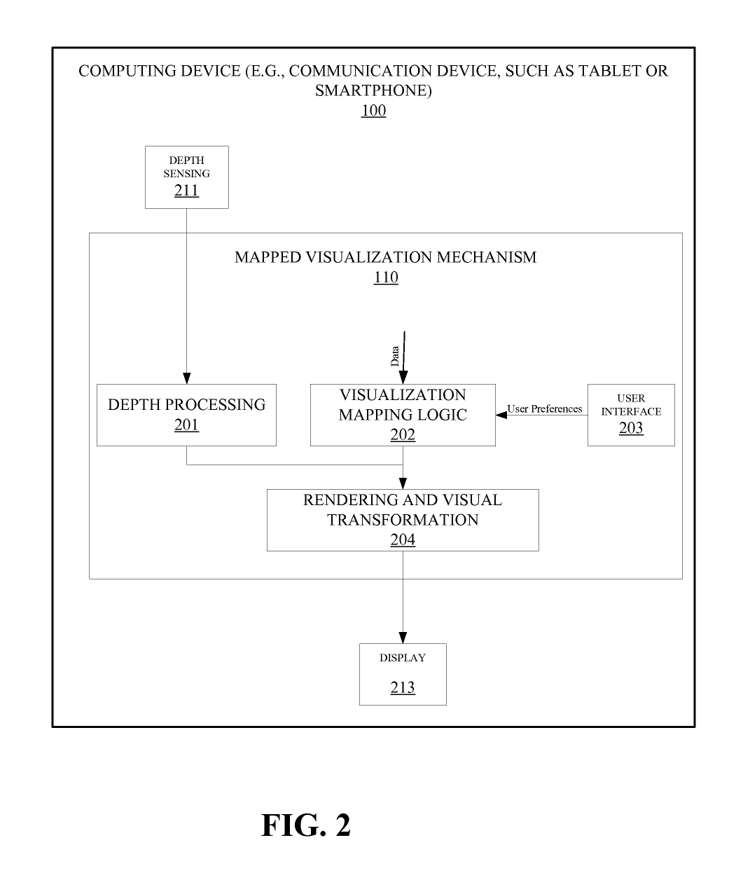

In another embodiment, mapped visualization mechanism 110 may be used for a sales team to visualize foot traffic through a grocery store by altering the appearance of popular shelf items according to data analytics. Mapped visualization mechanism 110 includes any number and type of components, as illustrated in FIG. 2, to efficiently perform environmentally mapped visualization, as will be further described throughout this document.

Computing device 100 may also include any number and type of communication devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones, personal digital assistants (PDAs), tablet computers, laptop computers (e.g., notebook, netbook, Ultrabook™ system, etc.), e-readers, media internet devices (“MIDs”), smart televisions, television platforms, wearable devices (e.g., watch, bracelet, smartcard, jewelry, clothing items, etc.), media players, etc.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

FIG. 2 illustrates a mapped visualization mechanism 110 according to one embodiment. In one embodiment, mapped visualization mechanism 110 may be employed at computing device 100 serving as a communication device, such as a smartphone, a wearable device, a tablet computer, a laptop computer, a desktop computer, etc. In a further embodiment, mapped visualization mechanism 110 includes any number and type of components, such as: depth processing module 201, visualization mapping logic 202, user interface 203 and rendering and visual transformation module 204. Further, computing device 100 includes depth sensing device 211and display 213 to facilitate implementation of mapped visualization mechanism 110.

It is contemplated that any number and type of components may be added to and/or removed from mapped visualization mechanism 110 to facilitate various embodiments including adding, removing, and/or enhancing certain features. For brevity, clarity, and ease of understanding of mapped visualization mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

Depth processing module 201 includes real-time volumetric reconstruction of a user's environment using a three-dimensional (3D) object scanning and model creation algorithm (e.g. KinectFusion™ developed by Microsoft®). Depth processing module 201 may also include depth maps as output. In such an embodiment, the depth maps are derived either directly from sensor 211 or as an end result of projecting depth from an accumulated model. In more sophisticated embodiments, depth processing module 201 incorporates an element of scene understanding, offering per-object 3D model output. In such an embodiment, this is achieved via image/point-cloud segmentation algorithms and/or user feedback via user interface 203.

Visualization mapping logic 202 receives data and takes in to account visualization intent (e.g., video gaming, storytelling, data analytics, etc.) as well as user preferences to assign transformations. According to one embodiment, data may include audio, financial data, scientific research data, etc. In a further embodiment, the data may be stored locally at computing device 100. However in other embodiments the data may be acquired from an external source (e.g. server computer). In such an embodiment, the data may be real-time sensor data acquired from elsewhere on the platform or networked sensors.

Rendering and visual transformation module 204 performs dynamic visualization. In traditional augmented reality applications, real world information (e.g., geometry, texture, camera pose, etc.) serves as background where the information anchors. However, the data and the real world environment does not mix. Meanwhile in virtual reality, the real world environment is replaced with digital information. According to one embodiment, visual transformation module 204 enables real world information to undergo transformation to encode data in visualization, while the visualization transforms a real world environment with a different look and feel. Thus, a user may recognize and interact with the transformed environment using existing physical and spatial skills.

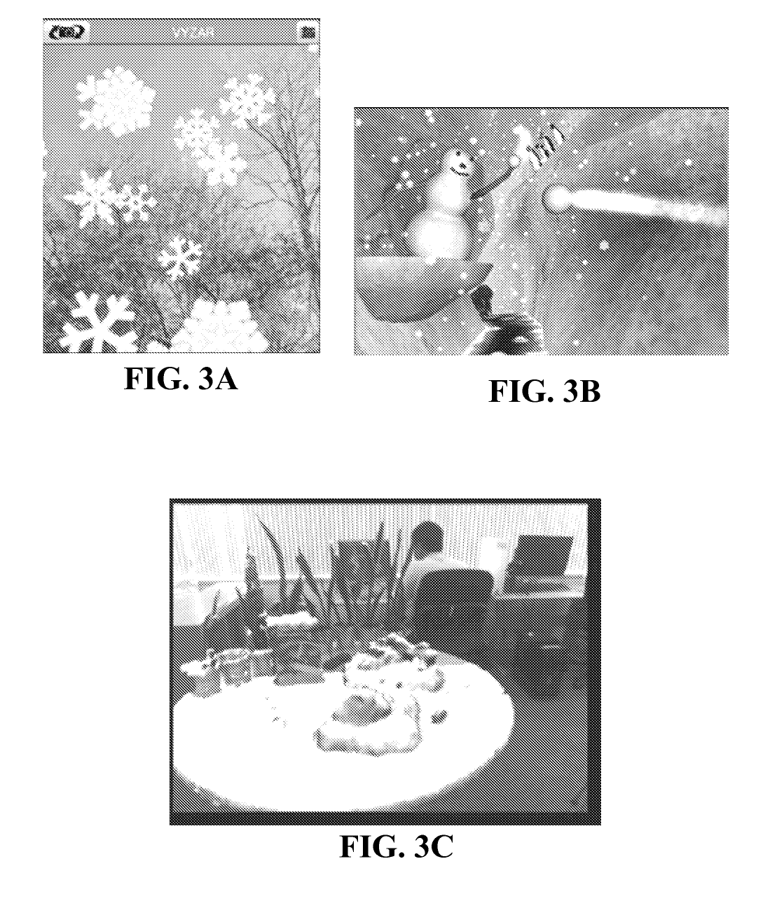

FIGS. 3A-3C illustrate the distinction between augmented reality, virtual reality and dynamic visualization performed by transformation module 204. FIG. 3A illustrates a screenshot of an exemplary augmented reality application in which augmented reality snow appears pasted on top of real world video since there is no understanding of the geometric information in the environment. FIG. 3B illustrates a screenshot of an exemplary virtual reality effect in which a virtual reality snow effect has no mapping to the real world. FIG. 3C illustrates a virtualization effect performed by transformation module 204. As shown in FIG. 3C, the snow is accumulated on top of the objects because the geometry of the world is calculated. In one embodiment, the amount of snow may reflect the data (e.g., sensors, video game data, etc.).

According to one embodiment, dynamic visualization includes a geometric manipulation scheme. Geometric transformation refers to scene modification, removal, animation, and/or addition based on existing geometric information from depth processing module 201. In music for example, a 3D geometry of a scene may be dynamically modulated to match the visualization intent. This modulation may include displacement, morphing, addition, or removal of geometry based on the data to visualize (e.g., the surface of your desk could be deformed to model topological terrain data). Geometric information may include volume, mesh, and point cloud data.

In a further embodiment, geometric manipulation may be implemented via manipulating on volume/mesh/point cloud directly, or via vertex shader. Vertex shader manipulation leverages processing resources and is computationally more efficient. Referring back to FIG. 3C, geometric transformation is shown such that amount of snow depends on geometric information (e.g., surface normal in this case) and the data source to be visualized. Further, the snow effect is implemented using a vertex shader. Thus, the vertex is displaced based on its current position and normal. The amount of displacement also depends on the data to be visualized.

In another embodiment, the visual manipulation may include texture manipulation to receive corresponding texture information for the geometry. Texture information enables users to recognize a connection between visualization information and a real world environment. In one embodiment, live/key-frame texture projection or volumetric (vertex) color acquisition is used to retrieve the information. Textural manipulation may also be able to include projection of Red-Green-Blue (RGB) color data on to the model, in addition to textural modifications intended to convey the visualization (e.g., re-colorization to show spatial or temporal temperature data). Thus, texture manipulation provides a balance between the visualization effects and the live RGB information of the real world environment.

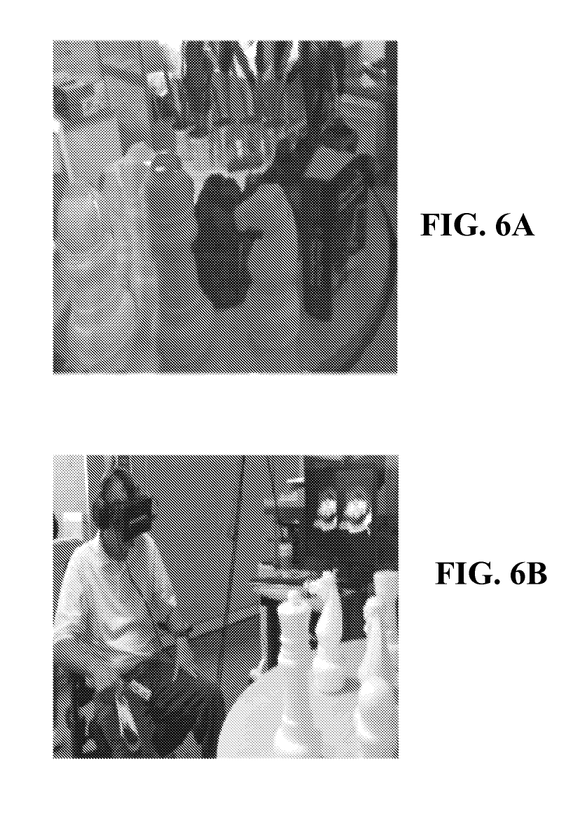

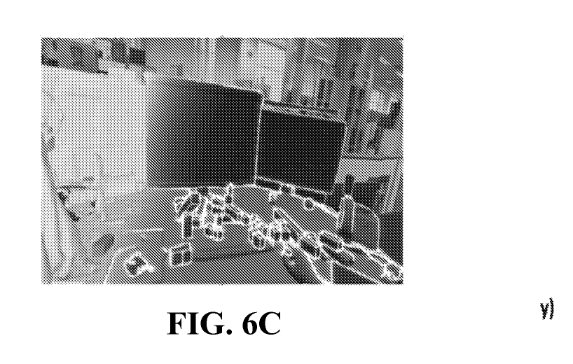

In a further embodiment, texture manipulation is implemented by overlapping, adding, removing and blending color information and changing a UV mapping (e.g., a three-dimensional (3D) modeling process of making a two-dimensional (2D) image representation of a 3D model's surface). In such an embodiment, texture manipulation is using an RGB camera video and other accumulated color information of the model. FIG. 6A illustrates a screenshot of a texture manipulation implementation according to one embodiment. In this example, texture color on live video is changed based on a music analysis result. In one embodiment, larger magnitude in a certain spectrum shows more of a green color than a purple color, while the color that reflects music data and the color from a live RGB camera feed are multiplied.

In yet another embodiment, the manipulation may also occur in an image space with respect to an aligned-depth map, which may be used for either direct visual effect, or as a means of reducing computational complexity for direct model manipulation. For example, if a physics simulation (such as a trajectory) is being visualized in a 3D space, it may be desirable to defocus or de-saturate areas outside of the impact point. If the intent of the visualization is a video game, post-processing effects could be used to re-render existing objects with a different material (e.g., a building suddenly appears as stone once it's been ‘flagged’ by an opposing team). Another example is dynamic lighting that would change the appearance and the mood conveyed in the visualization.

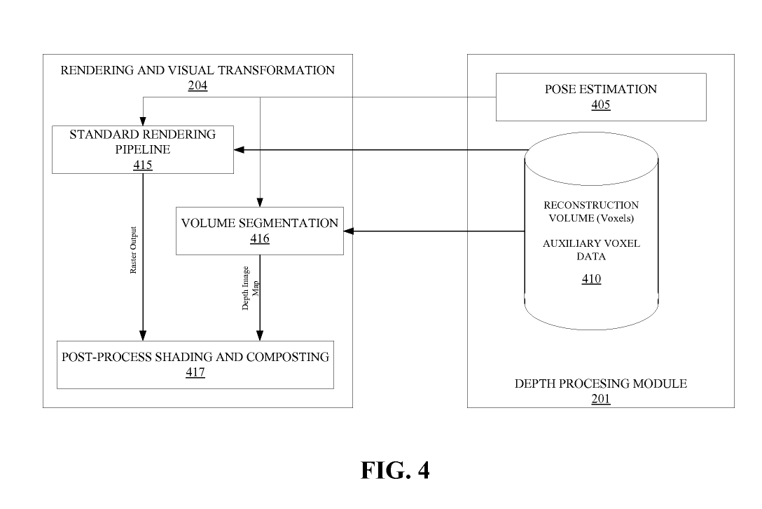

Another visual transformation process features image-based post-processing. FIG. 4 illustrates to one embodiment of a post-processing pipeline. In one embodiment, a reconstruction volume included within a database 410 within depth processing module 201 provides data (e.g., depth, normals, auxiliary stored data, segmentation, etc.) to enable a rendering pipeline 415 within transformation module 204 to perform scene manipulation in an image-space. This allows for rich visual transformation of an existing environment. In a further embodiment, auxiliary per-voxel data is transmitted from database 410 into a segmentation map at volume segmentation 416 to project into an image space. Subsequently, a raster output and a depth image map is received at post-processing shading and composting module 417 from rendering pipeline 415 and volume segmentation module 416, respectively, for compositing.

According to one embodiment, visualization mapping logic 202 may receive preferences via user interaction at user interface 203. Thus, because the data is rendered to map the environment, users can leverage their existing bodily and spatial skills to naturally interact with the visualization. For example, users moving their viewing angle from left to right could map to the scientific data collection in different time period. Another example is that users talking to a microphone will send out “shock waves” during music visualization in the space. With visualization in the environment, the user experience and interaction becomes more natural and immersive.

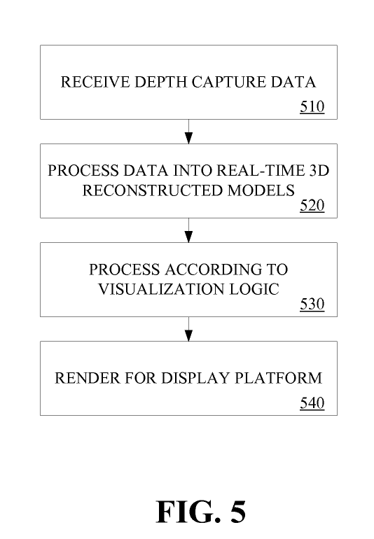

FIG. 5 illustrates a process for facilitating mapped visualization at computing device 100 according to one embodiment. The process may be performed by processing logic that may comprise hardware (e.g., circuitry, dedicated logic, programmable logic, etc.), software (such as instructions run on a processing device), or a combination thereof. In one embodiment, the process may be performed by mapped visualization mechanism 110 of FIG. 1. The processes are illustrated in linear sequences for brevity and clarity in presentation; however, it is contemplated that any number of them can be performed in parallel, asynchronously, or in different orders. For brevity, many of the details discussed with reference to FIGS. 1-4 may not be discussed or repeated hereafter.

At processing block 510, depth processing module 201 acquires RGB-D images from depth sensing device 211. At processing block 520, depth processing module 201 processes the RGB-D image data into real-time 3D reconstructed models. However in other embodiments the data may be processed into well-filtered depth maps. At processing block 530, rendering and visual transformation 204 directly manipulates and/or dynamically renders models according to the desired visualization mapping logic 202 over some set of data (e.g., music, spatial, financial, etc.). At processing block 540, the final result is rendered for display 213 at computing device 110. In various embodiments, display 213 may be implemented as see-through eye glass display, a tablet, virtual reality helmet or other display device. FIG. 6B illustrates a virtual reality implementation.

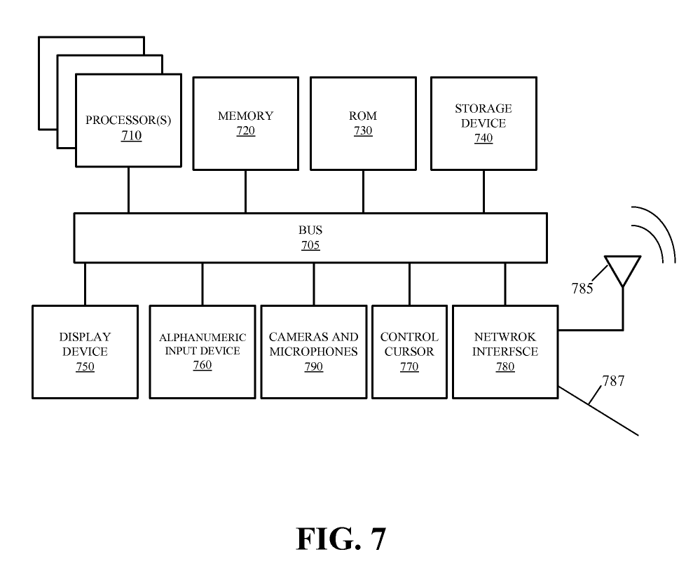

FIG. 7 illustrates an embodiment of a computing system 700. Computing system 700 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, etc. Alternate computing systems may include more, fewer and/or different components. Computing device 700 may be the same as or similar to or include computing device 100, as described in reference to FIGS. 1 and 2.

Computing system 700 includes bus 705 (or, for example, a link, an interconnect, or another type of communication device or interface to communicate information) and processor 710 coupled to bus 705 that may process information. While computing system 700 is illustrated with a single processor, electronic system 700 and may include multiple processors and/or co-processors, such as one or more of central processors, graphics processors, and physics processors, etc. Computing system 700 may further include random access memory (RAM) or other dynamic storage device 720 (referred to as main memory), coupled to bus 705 and may store information and instructions that may be executed by processor 710. Main memory 720 may also be used to store temporary variables or other intermediate information during execution of instructions by processor 710.

Computing system 700 may also include read only memory (ROM) and/or other storage device 730 coupled to bus 705 that may store static information and instructions for processor 710. Date storage device 740 may be coupled to bus 705 to store information and instructions. Date storage device 740, such as magnetic disk or optical disc and corresponding drive may be coupled to computing system 700.

Computing system 700 may also be coupled via bus 705 to display device 750, such as a cathode ray tube (CRT), liquid crystal display (LCD) or Organic Light Emitting Diode (OLED) array, to display information to a user. User input device 760, including alphanumeric and other keys, may be coupled to bus 705 to communicate information and command selections to processor 710. Another type of user input device 760 is cursor control 770, such as a mouse, a trackball, a touchscreen, a touchpad, or cursor direction keys to communicate direction information and command selections to processor 710 and to control cursor movement on display 750. Camera and microphone arrays 790 of computer system 700 may be coupled to bus 705 to observe gestures, record audio and video and to receive and transmit visual and audio commands.

Computing system 700 may further include network interface(s) 780 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 780 may include, for example, a wireless network interface having antenna 785, which may represent one or more antenna(e). Network interface(s) 780 may also include, for example, a wired network interface to communicate with remote devices via network cable 787, which may be, for example, an Ethernet cable, a coaxial cable, a fiber optic cable, a serial cable, or a parallel cable.

Network interface(s) 780 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 580 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 780 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 700 may vary from implementation to implementation depending upon numerous factors, such as price constraints, performance requirements, technological improvements, or other circumstances. Examples of the electronic device or computer system 700 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus comprising a depth sensing device to acquire image and depth data, a depth processing module to receive the image and depth data from the depth sensing device and process the image and depth data into real-time three-dimensional (3D) reconstructed models of the environment, a rendering and visual transformation module to manipulate models, textures and images based on a set of data and a user interface to enable user interaction with the rendered visualization by leveraging existing spatial and physical skills.

Example 2 includes the subject matter of Example 1, wherein the depth processing module processes the image and depth data into well-filtered depth maps.

Example 3 includes the subject matter of Examples 1 and 2, wherein the rendering and visual transformation module further dynamically renders the models.

Example 4 includes the subject matter of Example 1-3, wherein the rendering and visual transformation performs geometric manipulation to modulate a 3D geometry to match a visualization intent.

Example 5 includes the subject matter of Example 1-4, wherein the rendering and visual transformation performs texture manipulation to provide texture information for a three-dimensional geometry.

Example 6 includes the subject matter of Example 1-5, wherein the rendering and visual transformation performs post processing image based manipulation.

Example 7 includes the subject matter of Example 6, wherein the depth processing module comprises a pose estimation module to transmit data during post processing image based manipulation and a reconstruction volume.

Example 8 includes the subject matter of Example 7, wherein the rendering and visual transformation comprises a rendering pipeline to receive data from the tone estimation module and the reconstruction volume.

Example 9 includes the subject matter of Example 8, wherein the rendering and visual transformation further comprises a volume segmentation module to receive data from the reconstruction volume.

Example 10 includes the subject matter of Example 1-9, further comprising visualization mapping logic to assign transformations based on visualization intent and user preferences and transmit the transformations to the rendering and visual transformation module.

Example 11 includes the subject matter of Example 1-10, further comprising a display device to display the rendered models.

Some embodiments pertain to Example 12 that includes a method comprising acquiring depth image data, processing the image data into real-time three-dimensional (3D) reconstructed models, manipulating the models, textures, and images over a set of data, rendering the modified models, textures, and images for display and supporting interaction with the display based on existing spatial and physical skills.

Example 13 includes the subject matter of Example 12, wherein the processing comprises processing the depth image data into well-filtered depth maps.

Example 14 includes the subject matter of Example 12 and 13, further comprising dynamically rendering the models.

Example 15 includes the subject matter of Example 12-14, wherein processing the depth image data comprises performing geometric manipulation to modulate a 3D geometry to match a visualization intent.

Example 16 includes the subject matter of Example 12-15, wherein processing the depth image data comprises performing texture manipulation to provide texture information for a three-dimensional geometry.

Example 17 includes the subject matter of Example 12-16, wherein processing the depth image data comprises performing post processing image based manipulation.

Example 18 includes the subject matter of Example 12-17, further comprising assigning transformations based on visualization intent and user preferences and transmitting the transformations to the rendering and visual transformation module.

Example 19 includes the subject matter of Example 12-18, further comprising displaying the rendered models.

Some embodiments pertain to Example 20 that includes a computer readable medium having instructions, which when executed by a processor, cause the processor to perform the method of claims 12-19.

Some embodiments pertain to Example 21 that includes a system comprising means for acquiring depth image data, means for processing the image data into real-time three-dimensional (3D) reconstructed models, means for manipulating the models, textures, and images over a set of data, means for rendering the modified result for display and means for supporting interaction with the display based on existing spatial and physical skills.

Example 22 includes the subject matter of Example 21, wherein the means for processing comprises processing the depth image data into well-filtered depth maps.

Example 23 includes the subject matter of Example 21 and 22, further comprising means for dynamically rendering the models.

Example 24 includes the subject matter of Example 21-23, wherein the means for processing the depth image data comprises performing geometric manipulation to modulate a 3D geometry to match a visualization intent.

Example 25 includes the subject matter of Example 21-24, wherein the means for processing the image data comprises performing texture manipulation to provide texture information for a three-dimensional geometry.

Some embodiments pertain to Example 26 that includes a computer readable medium having instructions, which when executed by a processor, cause the processor to perform acquiring depth image data, processing the image data into real-time three-dimensional (3D) reconstructed models, manipulating the models, textures, and images over a set of data, rendering the modified result for display and supporting interaction with the display based on existing spatial and physical skills.

Example 27 includes the subject matter of Example 26, wherein the processing comprises processing the depth image data into well-filtered depth maps.

Example 28 includes the subject matter of Example 26 and 27 having instructions, which when executed by a processor, cause the processor to further perform dynamically rendering the models.

Example 29 includes the subject matter of Example 26-28, wherein processing the depth image data comprises performing geometric manipulation to modulate a 3D geometry to match a visualization intent.

Example 30 includes the subject matter of Example 26-29, wherein processing the image data comprises performing texture manipulation to provide texture information for a three-dimensional geometry.

Example 31 includes the subject matter of Example 26-30, wherein processing the depth image data comprises performing post processing image based manipulation and rendering.

Example 32 includes the subject matter of Example 26-31, having instructions, which when executed by a processor, cause the processor to further perform assigning transformations based on visualization intent and user preferences and transmitting the transformations to the rendering and visual transformation module.

Example 33 includes the subject matter of Example 26-32, having instructions, which when executed by a processor, cause the processor to further perform displaying the rendered models.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1.-25. (canceled)

26. An apparatus comprising:
a depth sensing device to acquire image and depth data;
a depth processing module to receive the image and depth data from the depth sensing device and process the image and depth data into real-time three-dimensional (3D) reconstructed models of the environment;
a rendering and visual transformation module to manipulate models, textures and images based on a set of data; and
a user interface to enable user interaction with the rendered visualization by leveraging existing spatial and physical skills.

27. The apparatus of claim 26, wherein the depth processing module processes the image and depth data into well-filtered depth maps.

28. The apparatus of claim 26, wherein the rendering and visual transformation module further dynamically renders the models.

29. The apparatus of claim 26, wherein the rendering and visual transformation performs geometric manipulation to modulate a 3D geometry to match a visualization intent.

30. The apparatus of claim 26, wherein the rendering and visual transformation performs texture manipulation to provide texture information for a three-dimensional geometry.

31. The apparatus of claim 26, wherein the rendering and visual transformation performs post processing image based manipulation.

32. The apparatus of claim 31, wherein the depth processing module comprises:
a pose estimation module to transmit data during post processing image based manipulation; and
a reconstruction volume.

33. The apparatus of claim 32, wherein the rendering and visual transformation comprises a rendering pipeline to receive data from the tone estimation module and the reconstruction volume.

34. The apparatus of claim 33, wherein the rendering and visual transformation further comprises a volume segmentation module to receive data from the reconstruction volume.

35. The apparatus of claim 26, further comprising visualization mapping logic to assign transformations based on visualization intent and user preferences and transmit the transformations to the rendering and visual transformation module.

36. The apparatus of claim 26, further comprising a display device to display the rendered models.

37. A method comprising:
acquiring depth image data;
processing the image data into real-time three-dimensional (3D) reconstructed models;
manipulating the models, textures, and images over a set of data;
rendering the modified models, textures, and images for display; and
supporting interaction with the display based on existing spatial and physical skills.

38. The method of claim 37, wherein the processing comprises processing the depth image data into well-filtered depth maps.

39. The method of claim 37, further comprising dynamically rendering the models.

40. The method of claim 37, wherein processing the depth image data comprises performing geometric manipulation to modulate a 3D geometry to match a visualization intent.

41. The method of claim 37, wherein processing the depth image data comprises performing texture manipulation to provide texture information for a three-dimensional geometry.

42. The method of claim 37, wherein processing the depth image data comprises performing post processing image based manipulation.

43. The method of claim 37, further comprising:
assigning transformations based on visualization intent and user preferences; and
transmitting the transformations to the rendering and visual transformation module.

44. The method of claim 37, further comprising displaying the rendered models.

45. A computer readable medium having instructions, which when executed by a processor, cause the processor to perform:
acquiring depth image data;
processing the image data into real-time three-dimensional (3D) reconstructed models;
manipulating the models, textures, and images over a set of data;
rendering the modified result for display; and
supporting interaction with the display based on existing spatial and physical skills.

46. The computer readable medium of claim 45, wherein the processing comprises processing the depth image data into well-filtered depth maps.

47. The computer readable medium of claim 45, wherein processing the depth image data comprises performing geometric manipulation to modulate a 3D geometry to match a visualization intent.

48. The computer readable medium of claim 45, wherein processing the image data comprises performing texture manipulation to provide texture information for a three-dimensional geometry.

49. The computer readable medium of claim 45, having instructions, which when executed by a processor, cause the processor to further perform:
assigning transformations based on visualization intent and user preferences; and
transmitting the transformations to the rendering and visual transformation module.

50. The computer readable medium of claim 45, having instructions, which when executed by a processor, cause the processor to further perform displaying the rendered models.
